(19) United States
(12) Patent Application Publication
(10) Pub. No.: US 2008/0075810 A1
(43) Pub. Date: Mar. 27, 2008

(54) Flavor application on edible substrates

(76) Inventors: Lu Fang Wen, Mason, OH (US); William John Henry JR., Covington, KY (US); Robert Leslie Swaine, Glendale, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/903,634

(22) Filed: Sep. 24, 2007

Related U.S. Application Data
(60) Provisional application No. 60/846,443, filed on Sep. 22, 2006.

(51) Int. Cl. A23L 1/22; A23L 1/00

(52) U.S. Cl. 426/87; 426/650

(57) ABSTRACT

Packages that contain at least two edible substrates, and at least one substrate has a flavor deposited on it and there is at least one other substrate in the package that has a different flavor deposited on it or that has no flavoring deposited on it. The package may contain at least two substrates in each package that have distinct flavors deposited on them, and the distinct flavors can be coordinated such that when they are eaten together they produce a different, coordinated flavor. The coordinated flavor can be, for example, hamburger, cheese burger, sour cream and onion, pizza, pepperoni pizza, and the like.

### CROSS REFERENCE TO RELATED APPLICATIONS

This application claims the benefit of and priority to provisional application No. 60/846,443, filed on Sep. 22, 2006, which is hereby incorporated by reference herein.

### FIELD OF THE INVENTION

This invention relates to methods for applying flavor to edible substrates and the products produced by these methods. More specifically, flavor is applied using new digital methods that provide targeted, precise, uniform and consistent application resulting in a better tasting product. The flavor can be applied in discreet areas or it can coat the substrate uniformly.

### BACKGROUND

Flavor addition to edible substrates, for example, snack foods is well known. Typically flavor and seasonings are applied by shaking a dry ingredient, for example, salt, over the substrate. This common method is fraught with inconsistent application and waste. The seasoning is placed in a trough and shook or sprinkled over the product. The seasoning falls randomly over the snack products sticking in some places and not sticking to others. The seasoning that does not stick to substrate falls into a collection tray where it is either recycled or discarded. When a flavor change is desired, for example, if one wants to produce Sour Cream and Onion flavor one day, and then on the same production line produce Cheese flavor the next day, emptying, cleaning and refilling of all the equipment is necessary. This is a very costly and time consuming process. These conventional processes for shaking seasonings onto edible substrates have many flaws discussed directly below. But one very simple constraint is that certain flavors are not available in a dry powder that can be sprinkled. Thus, the process method limits the choices available to consumers.

Further complicating this process is when multiple seasonings are applied. For example, Barbeque flavor is a very popular seasoning in certain areas. But it is a complex mixture of multiple different spices and seasonings. When sprinkled, certain spices stick to the substrate more readily than others. Thus, the seasoning that does not stick and is recycled, has a different concentration of spices than the original material, and hence, a different flavor. Simply put, as the seasoning is shook over the substrate and then recycled, the flavor being applied is constantly changing.

Moreover, the seasoning may add color to the substrate. Once again, Barbeque flavor is a good example because it typically has a dark red or burgundy color. When applied inconsistently to a snack chip, for example, different chips will have different colors. And there may be different colors (dark and light areas) on a single chip. This highlights to the consumer that the flavor on individual chips, and from one chip to another, is not consistent. The only thing worse than having poor control over a production process is having that lack of control highlighted in color on the final product.

Yet another issue with current seasoning systems is that often the dry seasonings do not stick at all. This is especially true when the substrate is also dry. Crackers, for example, have very little surface moisture after baking. Likewise, potato chips are relatively dry after frying because most of the oil is either absorbed into the base chip, or has cooled and solidified on the exterior. In any event, to get a dry seasoning to stick to a dry substrate a sticky substance must be applied first. The sticky substance must, of course, be edible and not have a negative impact on the flavor of the product. The most common sticky substance that meets these criteria is oil. Unfortunately, oil adds both fat and calories to the snack food. It goes without saying that adding fat and calories to a food product that is relatively high in both is not a desirable choice. Yet often, this is the only way to achieve good flavoring.

Further, another issue with current seasoning methods is that it can not apply different seasonings to one line of products to create variety inside of a package, nor it can deliver flavor to a targeted discreet area where a flavor signal is desired.

Another method used to apply seasonings is with a tumble drum, which is also limited to applying one flavor at a time. This conventional method has the same limitations mentioned above.

Finally, one more problem associated with food products flavored with dry seasonings is that the seasonings tend to come off on the consumer's hands. This is a notorious problem that leads to dirty fingers. Children often transfer the seasonings and their color to other objects such as the refrigerator doors, leather car seats, the household pet and other undesirable locations. This problem is endemic with the use of dry powder seasonings.

It is, therefore, desired to develop methods of applying flavor to an edible substrate that is consistent, repeatable, and preferably allows for selective application of flavor. A process that produces less waste will be highly desirable to those in skilled in the art. It is also desired that the methods of the present invention result in easier, faster and more cost effective methods when changing from one flavor to another. Further it is desired to produce flavored substrates that are uniformly flavored, and less messy than existing flavored edible substrates. Moreover, more flavor choices, are desired as is the ability to apply a flavor without adding oil or other extra adhesive materials. These and other advantages are accomplished by the present invention.

### SUMMARY

The present invention relates to packages comprising at least two edible substrates, wherein at least one substrate has a flavor deposited thereon and wherein there is at least one other substrate in the package that has a different flavor deposited on it or that has no flavoring deposited on it. In another aspect of the invention there are at least two substrates in the package that have distinct flavors deposited on them, and the distinct flavors are coordinated such that they are can be eaten together to produce a different, coordinated flavor. The coordinated flavor can be, for example, hamburger, cheese burger, sour cream and onion, pizza, pepperoni pizza, peanut butter and jelly, and mixtures thereof.

In yet another aspect of this invention one or more dry seasonings are applied to the substrate before or after the flavor is added. Preferably, the distinct flavors are deposited on the substrate by ultrasonic deposition, drop-on-demand inkjet printing and combinations of these.

By applying the flavor via a printing operation rather than common shaking or sprinkling, the flavor is applied more consistently and selectively. Because the flavor is applied via an ink-like substance, that is a liquid slurry or paste, there is far more flexibility in the type of flavor that can be applied. Moreover, waste is essentially eliminated, as is the recycle process. Change over from one flavor to the next can be as quick, clean and simple as changing a print head cartridge. Uniformity in flavor deposition is improved dramatically. Finally, as the carrier for the flavor evaporates or hardens, the flavor remaining on the substrate is tightly adhered to and/or absorbed into the substrate. That is, the flavor does not rub off on the hands of the consumer and the substrate is much less messy.

### DETAILED DESCRIPTION

Various publications and patents are referenced throughout this disclosure. All references cited herein are hereby incorporated by reference. All component or composition levels are in reference to the active level of that component or composition, and are exclusive of impurities, for example, residual solvents or by-products, which may be present in commercially available sources.

Referred to herein are trade names for components including various ingredients utilized in the present invention. The inventors herein do not intend to be limited by materials under a certain trade name. Equivalent materials (e.g., those obtained from a different source under a different name or catalog number) to those referenced by trade name may be substituted and utilized in the compositions, kits, and methods herein.

By the term “colorant” it is meant herein a composition comprising dye, pigment, natural colorants and mixtures thereof.

By the term “images” it is meant herein all pictorial representations that show an image in the traditional sense as well as all forms of text in all known or created languages and in all possible fonts and sizes of lettering.

By the term “dye” it is meant herein one or more of the colorants used in all types of ink.

By the term “nozzle” it is meant herein the area in some inkjet systems that direct the flow of ink immediately before the opening or orifice of the print head. It acts as a channel for the ink to use as it leaves the reservoir.

By the term “piezo” or “piezo electric” it is meant herein a Piezoelectric Ceramic Crystal. This material has the ability to expand and contract with the application of electric current.

By the term “surfactant” it is meant herein a material added to an ink to adjust the ink properties (e.g., viscosity, contact angle, wetting, and surface tension).

By the term “modifier” it is meant herein a component that changes fluid properties such as viscosity to establish particle stability, reduces the energy required for the mixed components to stay as one phase.

a. Edible Substrate

As used herein, “edible substrate” or “substrate” includes any material suitable for consumption that is capable of having an image disposed thereon. Any suitable edible substrate can be used with the invention herein. Examples of suitable edible substrates can include, but are not limited to, snack chips (e.g., sliced potato chips), fabricated snacks (e.g., fabricated chips such as tortilla chips, potato chips, potato crisps), extruded snacks, cookies, cakes, chewing gum, candy, bread, fruit, dried fruit, beef jerky, crackers, pasta, sliced meats, sliced cheese, pancakes, waffles, dried fruit film, breakfast cereals, toaster pastries, and pet foods. Further it also includes coffee tablets and coffee pods where the flavor or aroma printed can be dissolved into water during brewing.

In a preferred embodiment, the edible substrate comprises a fabricated snack piece, preferably a fabricated snack chip, and more preferably a fabricated potato crisp. Suitable snack pieces include those described in “Chip Frying Machine,” U.S. Pat. No. 3,520,248, issued Jul. 14, 1970, to MacKendrick; “Preparation of Chip-Type Products,” U.S. Pat. No. 3,576,647, issued Apr. 27, 1971, to Liepa; “Apparatus for Preparing Chip-Type Products,” U.S. Pat. No. 3,608,474, issued Sep. 28, 1971, to Liepa; and “Molding Device for Preparing Chip-Type Products,” U.S. Pat. No. 3,626,466, issued Dec. 7, 1971, to Liepa; Lodge in U.S. Pat. No. 5,464,643, and Villagran et al. in U.S. Pat. No. 6,066,353 and U.S. Pat. No. 5,464,642. In one embodiment, the fabricated snack chip is a fabricated potato crisp, such as that described by Lodge in U.S. Pat. No. 5,464,643, and Villagran et al. in U.S. Pat. No. 6,066,353 and U.S. Pat. No. 5,464,642. Other snack chips that can be used herein include those described in “Process for Making a Corn Chip with Potato Chip Texture,” U.S. Pat. No. 4,645,679, issued Feb. 24, 1987 to Lee, III et al.

In addition, the edible substrate can include pet foods such as, but not limited to, dog biscuits and dog treats.

The edible substrate can be in any suitable form. For example, the substrate can be a finished food product ready for consumption, a food product that requires further preparation before consumption (e.g., snack chip dough, dried pasta), or combinations thereof. Furthermore, the substrate can be rigid (e.g., fabricated snack chip) or non-rigid (e.g., dried fruit film). In one embodiment, the edible substrates are connected to one another (e.g., in the form of a dough sheet prior to cutting the individual pieces).

As used herein, “fabricated snack piece” or “snack piece” is broad enough to include a snack piece that has not yet been separated (e.g., cut) from a dough. For example, in one embodiment, an image is disposed upon a dough sheet, then the dough sheet is later cut into individual pieces. Furthermore, “fabricated snack piece” or “snack piece” is broad enough to include both cooked (e.g., fried) and un-cooked (e.g., dough) substrates.

Preferably, the edible substrates are provided as a stream of substrates. As used herein, “stream” means a continuous source of substrates. For example, a stream of substrates can include a plurality of substrates such as that provided by a conveyor belt or as a feed from a continuous, semi-continuous, or batch process.

b. Flavors

“Flavor” is defined as any additive that has a consumer perceptible effect on the taste or aroma of an edible substrate. Flavors include but are not limited to: individual flavors, for example, strawberry, barbeque, onion, vinegar, and the like; flavor notes, for example, sweet, sour, bitter and the like; and intensity, for example, hot or mild jalapeño pepper and the like. Flavors used in the products of this invention can include, for example savory and sweet flavors. Savory flavors include, but are not limited to, pizza, BBQ, sour cream and onion, bacon, cheddar cheese, oriental blends, onion types, ham, parmesan cheese, taco, smoke, and mixtures thereof. Sweet flavors include cinnamon brown sugar, butterscotch, caramel, caraway, maple, chocolate, fruit flavors, honey, vanilla, and mixtures thereof.

“Seasonings” are defined as anything that changes the taste of an edible substrate and is not a flavor. Examples of seasonings include, for example, salt, MSG, and the like.

“Distinct flavors” as used herein means two different flavors wherein an average consumer can taste that the flavors are different.

c. Flavor Application by Printing

Using an electronic printing device such as an ink jet device, on an edible substrate is known to the art. See, for example, Patent Publication Nos. US 20050163898 A1, US 20050058749 A1, and WO 05002360; all to Romanach et al., and all assigned to the Procter & Gamble Co. All three of the Romanach published patent applications are incorporated herein by reference. Likewise, printing with ultrasonic printers are known generally, although these printers are not currently used to print on edible substrates as disclosed herein. A description of ultrasonic printing can be found in co-pending U.S. patent application Ser. No. xx/xxx,xxx, to Wen et al., and assigned to the Procter & Gamble Co. The Wen patent application is incorporated herein by reference.

A large diversity of flavors can be printed via a digital printing device. As used herein, “digital” printing means the used of an electronically controlled, high speed, on-off printer, such as drop-on-demand digital printers and ultrasonic printers. Geometric images, patterns, letters, pictures of people, places and things, and the like can all be printed and stored electronically. While the present invention is directed to printing of flavors and seasonings, the use of electronic printing to print combinations of flavors, seasonings, and images is within the scope of the present invention.

Conventional dry seasoning shakers can, of course, be turned on and off mechanically. But this cannot be done in a high speed production line such that individual regions on individual fabricated snack pieces can be targeted. Moreover, precise images and patters cannot be applied with conventional shaker technology. Nor can tumble sprayers accomplish the accurate application of seasonings and spices as claimed in the present invention. Another technology generally unsuitable for use with the present invention is conventional icing applicators. Breakfast pastries and the like are often coated with, or decorated with streams of confectionary icing. This technology is generally too slow and inaccurate for the products and processes of this invention. Moreover, confectionary icing is too thick and sticky to be printed with the digital devices used in the present invention.

More specifically, the present invention relates to a package comprising at least two edible substrates, wherein at least one substrate has a flavor deposited thereon and wherein there is at least one other substrate in the package that has a different flavor deposited on it or that has no flavoring deposited on it. Preferably, all of the substrates have a flavor deposited on them and there are at least two substrates in the package that have distinct flavors deposited on them. The distinct flavors can be coordinated such that they are can be eaten together to produce a different, coordinated flavor, for example, hamburger, cheese burger, sour cream and onion, pizza, pepperoni pizza, peanut butter and jelly, and mixtures thereof. The different flavors can be digitally printed on different substrates sequentially in the same production line such that there is no post production mixing step necessary. The edible substrates in the package can all have the same composition, but this is not necessary.

Many variations of this invention can be practiced, for example, the edible substrate can have different shapes, and each different shape can be associated with one distinct flavor. The flavors are preferably deposited as a liquid, slurry or paste by digital printing using an edible carrier that can be selected from propylene glycol, propylene glycol derivatives, oil and combinations of these.

The flavored edible substrates of this invention are made by printing flavors and seasonings images onto a high-speed processing line by positioning an edible substrate onto a high speed processing line, delivering the substrate to an ink jet or ultrasonic printing station, and printing from one or more printers located within the printing station onto the substrate. Furthermore, the edible substrate is moved from the printing station to be cooked in a high temperature heating device (e.g., a fryer) where the substrate, or individual cut portions of the substrate, are fried or baked. “Cooking” as used herein includes baking, frying in oil, microwaving, vacuum drying, extrusion and combinations of these. Likewise the flavors and seasonings can be printed in this same manner after the substrate is cooked. Combinations of printing before and after cooking may also be used.

Preferably, the high speed processing lines herein operate at speeds of 50 feet per minute or higher. The DPI (dots per inch) of printing capability herein ranges from about 50 to about 1200. The ink(s) used herein will comprise edible surfactant or edible surfactant-based materials and are discussed in greater detail below. Any of a variety of digital printing devices can be used, such as those described in WO 01/94116 by Willcocks et al., published Dec. 13, 2001. In a preferred embodiment, an ink-jet printer disposes flavors, seasonings, and images on a dough sheet, which is cut into individual pieces then fried to form fabricated snack chips.

One example where this process can be used effectively is in the production of fabricated potato crisp snacks. Once printed with flavors, seasonings, images and combinations of these, the potato pieces may undergo further processing like frying, baking, salting or seasoning, and then portioned and packaged. A typical operation of this kind uses a First In First Out approach, which helps to maintain control of the product to minimize breakage and enable high density packing. As product is stacked and packed into containers, the packed stacks retain the potato crisps with flavors, seasonings, and images printed thereon in the same order in which they where printed which corresponds to the sequence of images used.

Any container from which the edible substrates can be dispensed, presented, displayed, or stored is suitable. Suitable containers include, but are not limited to, bags, canisters, boxes, bowls, plates, tubs, cups, paper wrappers, and cans. In one embodiment, the container is a round cylindrical canister that can contain uniformly-shaped fabricated potato crisps. Suitable such containers can include those described in “Packaging of Chip-Type Snack Food Products,” U.S. Pat. No. 3,498,798, issued Mar. 3, 1970, to Bauer et al.; and “Container Having a Membrane-Type Closure,” U.S. Pat. No. 3,973,719, issued Aug. 10, 1976, to Johnson, et al.

The method herein can be practiced by any suitable means. For example, it can be practiced in batch, semi-batch, and continuous mode. The method can be practiced using manufacturing environments having single manufacturing rows (e.g., single streams of edible substrates) or multiple manufacturing rows (e.g., multiple streams of edible substrates). Preferably, the edible articles are maintained in linear registration through their complete processing and such that a consecutive group of edible substrates can be selected to be inserted into a container.

d. Edible Inks

An Edible Ink is meant herein to include homogeneous liquids, slurries, or pastes containing a carrier or carriers and one or more flavors. Other ingredients may also be present. Edible inks for use in electronic printing devices, such as an ink jet device or an ultrasonic printing device, on an edible substrate are known to the art. See, for example, Patent Publication No. WO 06023615; to Wen et al., and assigned to the Procter & Gamble Co. The Wen published patent application is incorporated herein by reference.

It is important that the ink used in the ink jet or ultrasonic printer(s) 1) offer efficient printing onto the substrate, 2) that the ink is highly compatible with the internal mechanics and materials of the ink jet printer(s), 3) be able to be used in high-speed processing without significant (if any) clogging of the machinery in which it is used, 4) set and dry quickly on the substrate without smudging and smearing of the flavors, seasonings, and images, and 5) create consistently discernible images and/or patterns from the moment of actual printing, through the high-temperature heating phase and when packaged, through travel to a marketing venue, to a consumer's home. In other words, the flavors, seasonings, and images printed herein will substantially be the same flavors, seasonings, and images shown from their first printing to their ultimate point of consumption.

The flavoring of high volume of foods with digital printing systems presents a number of challenges since many requirements must be satisfied to enable digital printing on edible substrates on high speed processing lines (e.g., 50 feet per minute or greater). The ink compositions are especially important as they must be compatible with the edible substrate and with the process equipment necessary to print

The inks of this invention can comprise a non-aqueous based carrier, a surfactant, and a flavor. The inks may optionally include other active ingredients selected from the group consisting of a colorant, a perfume, sugar, amino acid, protein and mixtures thereof. Preferably the ink is printed onto a substrate on a high speed processing line via one or more piezo-electric drop-on-demand printers, ultrasonic printers and mixtures thereof. The surfactant is preferably selected from the group consisting of polysorbate based surfactants, lecithin based surfactants, sorbitan based surfactants and mixtures thereof, comprises less than about 50%, preferably, less than about 30%, even more preferably less than about 10% and most preferably less than about 5%, by weight oil and are preferably lecithin based. The melting point of the surfactants is preferred to be less than 70 C, more preferably less than 50 C, most preferably less than 40 C to keep the ink flowable at room temperature. The inks herein may further comprise a viscosity modifier, e.g., glycerin, and less than about 50%, preferably, less than about 30%, even more preferably less than about 10% and most preferably less than about 5%, by weight water, and the non-aqueous based carrier comprises a glycol based liquid. The inks of this invention are preferably edible as are the substrates they are printed on.

The edible inks of the present invention may also comprise other optional materials to further enhance the performance of the ink. These materials include thickeners, anti-foamers, and anti-microbial agents. A thickener that could be used with the present invention is Glycerin. This material helps to increase viscosity and serves as a humectant to avoid drying out of the ink exposed at the open nozzle. It could be used in the range of about 0 to about 50% of the ink composition. An anti-foamer that could be used with the present invention could be Iso-Propyl Alcohol (IPA). This material serves to better clean the nozzles upon droplet ejection, to maintain straighter jets, as an anti-foamer, to improve wetting, and to reduce viscosity. It could be used up to about 2% of the ink composition. Higher levels may be used in accordance with regulatory limits in various countries. Other short chain alcohols like ethanol or butanol may be used as antifoamers. Anti-microbial agents that could be used with the inks of the present invention include Methyl Paraben and Propyl Paraben. Iso-Propyl Alcohol (IPA) and Propylene Glycol (PG) (and optionally ethanol) also exhibit some level of anti-microbial activity.

The surfactants used in the inks of the present invention decrease the setting time of the ink on the edible substrates. This is important if the edible substrate is to undergo further processing like a heating step (e.g., frying or baking) that may smear or render the image less readable if the ink is not set on the surface prior to that step. If the ink does not set quickly enough, then the print head may need to be located further away from the subsequent step which may be inconvenient. This problem can be compounded if multiple colors are being printed on the substrate that may require a longer time to set if more ink is used than in a single color application.

The contact angle is one measure we can use to determine how quickly the ink sets up on the substrate. The contact angle measures the angle of the one droplet against the substrate at the point of contact. Over time, the contact angle changes because the droplet spreads over the substrate surface and/or is absorbed into the substrate.

Specific surfactants varying in their structure and properties that could be used with the present invention include but are not limited to synthetic surfactants, natural surfactants that are isolated and/or purified and modifications of natural surfactants. Synthetic surfactants include but are not limited to] diacetyl tartrate esters of monoglycerides [DATEM], acetylated monoglyceride [AcMG], lactylated monoglyceride [LacMG], and propylene glycol monoester [PGME]), sorbitan derivatives (e.g., sorbitan monostearate, sorbitan monooleate and sorbitan tristearate), polyhydric emulsifiers (e.g., sucrose esters and polyglycerol esters like polyoxyethylene (20) sorbitan monostearate [Polysorbate 60], polyoxyethylene (20) sorbitan tristearate [Polysorbate 65], and polyglycerol monostearate. ‘Ryoto Sugar Ester’ (sucrose fatty acid esters) and ‘Ryoto Polyglycerol Ester’ (polyglycerol fatty acid esters) are also acceptable surfactants for use herein. Both are safe and excellent emulsifiers/surfactants, and are used in a wide range of food applications. ‘Ryoto Sugar Ester’ is manufactured from natural sucrose and fatty acid esters of vegetable origin, and ‘Ryoto Polyglycerol Ester’ is made from natural glycerol and fatty acids of vegetable origin. Additional surfactants suitable for use in the present invention include anionic emulsifiers (e.g., sodium stearoyl lactylate [SSL], sodium stearyl fumarate, and sodium dodecyl sulfate [SDS]). Natural surfactants include but are not limited to lecithin which comprises surface active components phosphatidylethanoalamine (PE), phosphatidylinositol (PI), and phosphatidylcholine (PC). PC and PE are amphoteric surfactant species that can be either cationic N+) or anionic (P═O—) depending upon the pH of the solution. PI is an anionic surfactant that carries a negative charge on the active portion of the molecule (P—O—). Lecithin typically also comprises triglycerides. Low triglyceride lecithins are preferred as triglycerides can separate from the ink solution. The amount of lecithins added are preferably less than about 30% by, more preferably less than about 20%, and even more preferably less than about 10% and most preferably less than about 5% by weight. Modified natural surfactants include but are not limited to lysolecithin (enzyme modified) and acetylated lecithin.

The selection of a specific surfactant for a particular ink is a function of its dispersability in ink, its impact on surface tension over the limited time that ink is ejected from the nozzle until a droplet is formed, its impact on ink visco-elasticity, viscosity and ability to maintain an ink in liquid state at room temperature (about 25 C).

Some surfactants like lecithin can provide dispersability challenges. The dispersability is important to avoid separation of the surfactant from the ink solution and prevent blockage of the print head nozzles. Lecithins in liquid or solid form are preferred versus granular types.

Propylene Glycol (PG) is a suitable base for the edible inks of the present invention for use with digital printer print heads, since it provides for the base requirements of surface tension (˜40 dyns/cm), and acts as the carrier of the food colors or dyes.

Glycerin is another suitable co-solvent for the edible inks of the present invention for use with digital printer print heads, since it provides a large flexibility of viscosity adjustment at various temperatures (viscosity range from 1490 cps to 147 cps from 20 c to 70 c). Use of glycerin as a viscosity enhancer (1490-147 cps/20-70 c) in combination with propylene glycol (58.1 cps at 20 c).

Food colors are used in some embodiments of the present invention. This includes, but not limited to dyes, natural colorants and pigments. However, dyes are typically desirable because dyes typically are salts of sulfuric or carboxylic acids, making them soluble. Since they are soluble, they are ideal for jet printing applications, but they do not provide the resistance characteristics that are desired for packaging applications. Pigments, unlike dyes, are colorants that are insoluble in water and most solvents. Dispersion of pigments into ink has been a challenge due to their limitation on solvent selection for edible inks and requirements on particle size reduction.

Optionally a food dye may be pre-dissolved first into water and then incorporated as a water-dye solution into the propylene glycol (PG), since at least some food dyes do not incorporate into PG as readily as they do in water. If water is used to pre-dissolve the food dye, the minimum amount of water will be used to minimize the impact of water on reducing final ink viscosity and minimize any increase in surface tension, both of which impact jetting performance. Also, as noted earlier, the least amount of water is desirable to minimize any interference of the water with the adhesives of the diaphragm. In one embodiment, food dye is pre-dissolved in water at the maximum solubility of the dye in water, and this solution is incorporated into the PG base in sufficient amount to load the required level of dye desired. In another embodiment, a solution of 20% food dye with 80% water is formed and added to the PG base at 2%. The level of water or moisture in the final ink is preferred to be less than 50% by weight, more preferably less than 35% by weight, even more preferably less than 20% by weight, yet more preferably less than 10% by weight and most preferably less than 5% by weight. Higher levels of water are possible but that can reduce print head life by weakening the bonding material used as adhesives of the diaphragm.

Commercially available dyes and pigments used in ink formulation, however, can result in ink aggregation, ink crystal growth and nozzle blockage during and after jetting. To minimize and control these issues the dyes are purified to a low salt level, such as level of sulfate content of less than 50 ppm (parts per million).

The level of pH is also controlled to the range of 4 to 10, preferably 5 to 8, which may prevent the crystal formation of the salt at low pH. In addition, some dye shades are pH sensitive, with too broad a range of pH and can lead to change of the color shade from the original design. Too high of pH is also a limitation for the dye solubility and can lead to a dye becoming insoluble and precipitate out of the solution.

Preparation of an ink involves combination of all ingredients and mixing for sufficient time to achieve a uniform dispersion. The mix time will vary with the equipment used from a few seconds to up to 1 hour. High shear mixers can also be used with care to not inducing an excessive amount of foam during mixing. The ink is filtered through a filter membrane with a porous size of less than about 5 micrometers, preferably less than 0.2 micrometers. Preheating the surfactant and main ink carrier to a temperature above the melting temperature of the surfactant, particularly for high viscosity surfactants, can further ease incorporation of the surfactant into the ink.

Preparation of the Edible Ink for an ultrasonic nozzle involves a similar process, except that the filtration step uses a porous size that matches the ultrasonic nozzle selected.

### EXAMPLES

Embodiments of the present invention are demonstrated by the following non-limiting examples.

### Example 1

A potato dough is formed, sheeted and transported to a printing station. An electronic image is selected that includes various flavors to be printed onto the sheeted dough. The dough is printed with an ink jet printer following the electronic image. The printed dough is then cut into individual dough pieces that are loaded into molds and fried within the molds. The image disposed fried potato snack pieces are removed from the molds, salted and conveyed to a packing station where the snack pieces are portioned and inserted into canisters

### Example 2

Cheeseburger: A canister of crisps made according to Example 1 has the crisps arranged in ‘stacks’ of 4 different flavors. A stack of 4 crisps comprise the different components in a cheeseburger. Consumers can chose to consume each crisp separately or all four simultaneously. The four crisps were comprised of the following:

| | Ingredient Statement: |
|---|---|
| Crisp | Dried Potatoes, Vegetable Oil (Contains one or more of the |
| 1 - | following: Corn Oil, Cottonseed Oil, and/or Sunflower Oil), |
| Dill | Rice Flour, Wheat Starch, Maltodextrin, Salt and Dextrose. |
| | Contains 2% or less of: Whey, Sodium Diacetate, Lactose, |
| | Monosodium Glutamate, Citric Acid, Spice, Spice Extracts, |
| | Onion Powder, Soybean Oil, Garlic Powder |
| Crisp | Dried Potatoes, Vegetable Oil (Contains one or more of the |
| 2 - | following: Corn Oil, Cottonseed Oil, and/or Sunflower Oil), |
| Ketchup | Rice Flour, Wheat Starch, Maltodextrin, Salt and Dextrose. |
| | Contains 2% or less of: Sugar, Tomato Powder, Flavor, |
| | Sodium Acetate, Spices, Monosodium Glutamate, Citric Acid, |
| | Salt, Color, Milk Ingredients, Disodium Guanylate, Disodium |
| | Inosinate, Artificial Flavor, Mono- And Diglycerides. May |
| | Contain Dextrose. |
| Crisp | Dried Potatoes, Vegetable Oil (Contains one or more of the |
| 3 - | following: Corn Oil, Cottonseed Oil, and/or Sunflower Oil), |
| Cheese | Rice Flour, Wheat Starch, Maltodextrin, Salt and Dextrose. |
| | Contains 2% or less of: Cheddar Cheese (Pasteurized Milk, |
| | Whey Protein Concentrate, Cheese Cultures, Salt, Enzymes), |
| | Parmesan Cheese (Pasteurized Milk, Whey Protein |
| | Concentrate, Cheese Cultures, Salt, Enzymes), Salt, |
| | Monosodium Glutamate, Whey, Partially Hydrogenated |
| | Soybean Oil, Sugar, Natural Flavors, Onion Powder, Dextrose, |
| | Buttermilk, Lactose, Disodium Phosphate, Citric Acid, Nonfat |
| | Milk, Lactic Acid, Autolyzed Yeast Extract, Yellow 5 Lake, |
| | Turmeric Extract (Color), Yellow 6, Disodium Inosinate, |
| | Disodium Guanylate, Artificial Flavor And Yellow 5. |
| Crisp | Dried Potatoes, Vegetable Oil (Contains one or more of the |
| 4 - | following: Corn Oil, Cottonseed Oil, and/or Sunflower Oil), |
| Cheese- | Rice Flour, Wheat Starch, Maltodextrin, Salt and Dextrose. |
| burger | Contains 2% or less of: Whey, Hydrolyzed Soy Protein, |
| | American Cheese (cultured milk, cream milkfat, salt, sodium |
| | citrate, lecithin, enzymes), Sugar, Onion Powder, Partially |
| | Hydrogenated Soybean, Salt, Maltodextrin, Citric Acid, |
| | Modified Corn Starch, Spices, Disodium Phosphate, Garlic |
| | Powder, Artificial Colors (Yellow 5, Yellow 6, Turmeric |
| | Extract), Sodium Diacetate, Cheddar Cheese (cultured milk, |
| | salt, enzymes), Lactic Acid, Natural and Artificial Flavors, |
| | Disodium Inosinate, Disodium Guanylate, Mustard Seed, |
| | Natural Smoke Flavor. |

### Example 3

Pringles Sour Cream & Onion and Regular: A canister of crisps made according to Example 1 has product arranged with alternating flavors. In this Example, the product alternates between a crisp flavored with Sour Cream & Onion seasoning and a crisp with no added flavoring.

| | Ingredient Statement: |
|---|---|
| Crisp 1 - | Dried Potatoes, Vegetable Oil (Contains one or more of the |
| Sour | following: Corn Oil, Cottonseed Oil, and/or Sunflower Oil), |
| Cream & | Rice Flour, Wheat Starch, Maltodextrin, Salt and Dextrose. |
| Onion | Contains 2% or less of: whey, salt, dextrose, partially |
| | hydrogenated coconut oil, monosodium glutamate, onion |
| | powder, sugar, nonfat milk, sour cream (cream, nonfat milk, |
| | cultures), cultured nonfat milk, natural flavors, citric acid, |
| | lactic acid, disodium inosinate and disodium guanylate, |
| | sodium caseinate, invert sugar and malic acid with not more |
| | than 2% silicon dioxide and tricalcium phosphate as |
| | processing aids. |
| Crisp 2 - | Dried Potatoes, Vegetable Oil (Contains one or more of the |
| Regular | following: Corn Oil, Cottonseed Oil, and/or Sunflower Oil), |
| | Rice Flour, Wheat Starch, Maltodextrin, Salt and Dextrose. |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A package comprising at least two edible substrates, wherein at least one substrate has a flavor deposited thereon and wherein there is at least one other substrate in the package that has a different flavor deposited on it or that has no flavoring deposited on it.

2. The package of claim 1 wherein all of the substrates have a flavor deposited on them and there are at least two substrates in the package that have distinct flavors deposited on them.

3. The package of claim 2 wherein the distinct flavors are coordinated such that they can be eaten together to produce a different, coordinated flavor.

4. The package of claim 2 wherein the coordinated flavor is selected from the group consisting of hamburger, cheese burger, sour cream and onion, pizza, pepperoni pizza, peanut butter and jelly, fruit mixtures, caramel apple, cinnamon sugar, and mixtures thereof.

5. The package of claim 1 wherein the different flavors are digitally deposited on different substrates sequentially in the same production line such that there is no post production mixing step necessary.

6. The package of claim 1 wherein the edible substrates all have the same composition.

7. The package of claim 6, wherein the edible substrate have different shapes, and further wherein each different shape is associated with one distinct flavor.

8. The package of claim 1 wherein the flavors are deposited as a liquid, slurry or paste.

9. The package of claim 8 wherein each flavor is deposited along with an edible carrier.

10. The package of claim 9 wherein the carrier is selected from propylene glycol, propylene glycol derivatives, oil and combinations of these.

11. The package of claim 1, wherein one or more dry seasonings are applied to the substrates.

12. The package of claim 1, wherein the distinct flavors are colored so they are visible to a consumer.

13. The package of claim 2 wherein the distinct flavors are colored so they are visible to the consumer, and each distinct flavor has a different color.

14. The package of claim 1 wherein the distinct flavors are deposited on the substrate by ultrasonic deposition, drop-on-demand inkjet printing and combinations of these.

15. The package of claim 14 wherein dry seasonings are also sprinkled onto the substrates.

16. The package of claim 1 wherein the flavors are not in the form of icing.

17. The package of claim 1 wherein the edible substrate is cooked before the flavors are applied.

18. The package of claim 17 wherein the substrate is cooked by frying in oil, baking, microwaving, vacuum drying, extrusion and combinations of these.

19. The package of claim 1 wherein the substrate is cooked after the flavors are applied.

20. The edible substrate of claim 19 wherein the substrate is cooked by frying in oil, baking, microwaving, vacuum drying, extrusion and combinations of these.

21. The package of claim 1 wherein at least one substrate has an image printed on it.

22. The package of claim 21 the image illustrates a food or a flavor and that food or flavor corresponds to the flavor deposited on the substrate containing the image.

23. The package of claim 1 wherein all of the distinct flavors are deposited randomly on substrates such that the package has a random distribution of flavors in it.
